(19) United States
(12) Patent Application Publication
(10) Pub. No.: US 2018/0170438 A1
(43) Pub. Date: Jun. 21, 2018

(54) Front hood, vehicle with such front hood as well as method for producing the same

(71) Applicant: FAIST ChemTec GmbH, Worms (DE)

(72) Inventors: Jürgen Cordes, Braunschweig (DE); Julia Bierbaum, Braunschweig (DE); Torsten Kind, Sassenburg (DE); Knut Böttcher, Hordorf (DE); Lukas Rafalski, Braunschweig (DE); Zdislaw Kornacki, Nidderau (DE); Stephan Riebel, Bodenheim (DE); Christian Hardt, Kelsterbach (DE); Frederick Luis Schwab, Frankfurt (DE)

(21) Appl. No.: 15/784,320

(22) Filed: Oct. 16, 2017

(30) Foreign Application Priority Data
Oct. 14, 2016 (DE) 10 2016 220 153.0

(51) Int. Cl. B62D 21/15; B62D 25/10; B60R 13/08; B60R 21/34

(52) U.S. Cl. CPC B62D 21/152; B62D 25/105; B60R 2021/343; B60R 13/0846; B60R 21/34; B60R 13/083

(57) ABSTRACT

A front lid for a vehicle, especially a motor vehicle, which front lid includes an outer panel, where, in a predetermined region or in the entire area of the front lid below the outer panel, at least one inertia mass is arranged, and the inertia mass is formed of a flexible heavy layer.

### CROSS REFERENCE TO RELATED APPLICATION

This application is related to and claims the benefit of German Patent Application Number 10 2016 220 153.0 filed on Oct. 14, 2016, the contents of which are herein incorporated by reference in their entirety.”

### TECHNICAL FIELD

Front lid, vehicle having such front lid as well as a method for manufacturing of the same

### BACKGROUND

In case of a frontal collision of a vehicle with a pedestrian, the same may be hit by the bumper and subsequently, with the torso or the head, respectively, and may impact especially onto the front lid, also named as hood, whereby, as a consequence, physical injuries may be expected. Owing to this fact, the automotive manufacturing industry has made extensive efforts to overcome this disadvantage and to considerably minimize physical injuries of pedestrians. Basically, it is required to reconcile basic stiffness of the front lid and maximum possible pedestrian protection. In this context, the so called head impact test is an important test criterion. It is intended to obtain a minimum possible HIC value (HIC=Head Injury Criterion). As a matter of fact, it has already been known to locally form the front lid in predetermined regions thereof such that in case of an eventual collision with a pedestrian, impact energy will be absorbed to the maximum possible gentleness of the pedestrian. Those regions will be determined by way of impact devices simulating impact with the head of a pedestrian by impactors, also referred to as head ball, in impact testing, wherein the impactors are targeted to the predetermined regions with a specified velocity. In order to allow for pedestrian-friendly configuration of a vehicle by the use of purposefully selected measure, the relevant geometrical parameters and material parameters will be evaluated by way of an optimum retardation curve. That optimum retardation curve allows for conversion of impactor energy on a deformation path as small as possible by employing a force displacement-curve that is practically attainable. It has been found that, besides that deformation path, geometrical stiffness of the hood, mass inertia and yield strength of the material are decisive to the force displacement-curve of the impactor.

Conventionally, front lids were fabricated from a steel sheet. For some time, said front lids have also been fabricated of aluminum or an aluminum alloy resulting in savings in weight. In extensive trials in the course of said head impact test, front lid panels of aluminum or an aluminum alloy, respectively, have shown to result in poorer values in relation to HIC and deformation path than with front lid panels of steel. The reason for this is the inertia mass of the front lid panels of aluminum or an aluminum alloy, respectively, being too low, since the inertia mass is the main reason for the deceleration of the impactor within the first 4 ms. In view of this fact, FIG. 7 (prior art), for a better understanding, shows a diagram including three curves of acceleration (a) vs. time (t) A, B, C, named as head impact acceleration curve, wherein curve A relates to a front lid of steel and the curves B and C each relate to a front lid panel of a specific aluminum alloy. The optimum height of the first acceleration peak, caused by said mass inertia of the front lid panel, is located at 170 g. The ratio between the first acceleration peak and the second acceleration peak optimally is ⅔ to ⅓. As it is seen in FIG. 7, this applies to the front lid panel of steel (curve A). Contrary to this, FIG. 7 also shows that the first peak of the front lid panels of an aluminum alloy (curves B and C) is below that of the steel panel. Moreover, the second peak of the front lid panels of an aluminum alloy is higher than the first peak thereof. From this, the above-mentioned advantage of front lids of steel is obvious.

In order to optimize front lids in relation to an eventual head impact, prior art teaches various approaches. Thus, DE 10 2008 034 132 A1 describes a hood arrangement for a vehicle having an energy absorbing inner cushioning structure for example of a plastic material. The cushioning structure comprises an upper layer or cover, a recessed coating and a bottom layer or inner film. The said recessed coating has a plurality of polyhedral bulges or cushioning bulges. The upper layer is attached to an inner surface of a hood exterior panel of plastic or metal, such as steel or aluminum. The bulges should be suitable, to absorb and to dampen indentation loads that are transferred to the hood arrangement, and resulting forces that are transferred to an object and that result from a collision between the object and the hood arrangement. Moreover, for optimizing the head impact results (HIC), it has been known to increase the mass inertia at least of the predetermined regions of an eventual head impact, in view of that fact, DE 100 38 430 A1 describes a hood on a vehicle for absorbing an impact having a top panel and a back structure as well as at least one absorber mass as an inertia mass and a vibration absorber. In a predetermined region of the hood, an attenuating layer filling the intermediate space between the top panel and the back structure is provided, wherein said absorbing mass is arranged in the attenuating layer or at the side facing away from the back structure. With this measure, the head injury criterion (HIG) in said region is to be reduced by reducing the vibration of the acceleration of the vibration system formed therein of an impactor and the hood, and the energy absorption capacity is to be increased. The attenuating layer consists of a foamed plastic, especially foamed hard plastic, such as polyurethane, and the absorbing mass consists of sheet steel.

### BRIEF SUMMARY

Especially, in view of the last-described prior art (DE 100 38 430 A1), the disclosure provides an alternative front lid for a vehicle, especially motor vehicle, which easily builds and still has a minimum possible HIC value, at least in predetermined regions of the same. Furthermore, the disclosure provides a vehicle, especially motor vehicle, having such front lid. Finally, the disclosure provides a method for manufacturing said front lid.

Starting from a front lid for a vehicle, especially motor vehicle, which front lid comprises an outer panel, wherein at least one inertia mass is locally arranged in a predetermined region or in the entire area of the front lid below the outer panel, said inertia mass is formed by a flexible heavy layer.

By the use of a heavy layer, a simple and low cost measure for adjusting the mass inertia of front lids or predetermined regions of the same to a HIC value as small as possible is found. It has surprisingly been shown in extensive trials that said heavy layer, which, according to prior art, on the one hand is used in a spring-mass system, for example in combination with a plastic foam, in various embodiments for component anti-drumming (reduction of body sound), especially in motor vehicles (cf. e.g. EP 1 057 694 A2, EP 0 316 744 A2, EP 0 253 376 A2), on the other hand also provides very good results as an inertia mass in adjusting mass inertia of front lids or predetermined regions of the same or in achieving a HIC value as small as possible. For the adjustment of said mass inertia, essentially a flexible mass is used, which advantageously does not cause any increase in stiffness of the front lid.

It is preferred that said inertia mass is formed in the form of the flexible heavy layer as a matt-like built-on or built-in part—mass pad. Such a mass pad permits easy and low cost production and mounting and, during adjustment of the mass inertia, for example, allows adaption to the desired result by trimming. It is preferred that the mass pad is mounted to the bottom side of the outer panel. It is furthermore preferred that the mass pad is mounted to the outer panel by CDC. By CDC (CDC=cathodic dip coating), an electrochemical dip coating method is generally understood by the persons skilled in the art, wherein the deposition of varnish is performed by the chemical reaction of a binder. This method is accompanied by the use of method temperatures of at least 200° C. Contrary to this, the mass pad may also be introduced or inserted, and maintained, respectively, in a cavity formed between the outer panel and an internal structure that is attached to the outer panel and stiffening the same. In this case, providing the front lid with the mass pad is preferably performed prior to CDC. It is understood that in this case the heavy layer must be capable of CDC. This circumstance requires a mass pad capable of CDC, which, accordingly, has temperature resistance sufficiently high of at least 200° C. during at least 40 minutes as well as sufficient adhesion to the outer panel in a run of at least 15 minutes at least 160°. Alternatively, the inertia mass may also be injected/become injected into said cavity between the outer panel and the internal structure in the form of the heavy layer, and may there be cured into a mass, which is highly flexible and, as already set forth above, ideally does not introduce additional stiffness into the structure of the front lid. This measure is preferably also performed prior to CDC, if the injected mass or heavy layer, respectively, is capable of CDC. It is understood that injection of the heavy layer following CDC is also encompassed by the disclosure. In this case, it is not a prerequisite that the heavy layer is capable of CDC. At least the flexible heavy layer should be designed such that, as an attached or inserted mass pad, respectively, or as an injected composition, the flexible heavy layer tolerates temperatures generally encountered in the engine compartment during operation of the vehicle, without changing the characteristics of the injected composition.

According to a first advantageous embodiment of the inertia mass in the form of the flexible heavy layer, the heavy layer comprises a bituminous composition, which is easy to process and is of low-cost. By bitumen, generally both a naturally occurring mixture and a mixture of various organic substances obtained by vacuum distillation of petroleum is understood. Preferably, such a heavy layer has a density of about 2.0 to about 2.6 g/cm³. In order to confer advantageous characteristics to the bituminous composition, especially to suppress hardening and embrittling of the bituminous composition over the time as well as to set the desired elasticity of the bituminous composition, the bituminous composition preferably contains plastic. Said plastic may for example be formed by a thermoplastic polymer, such as a copolymer, e.g. polypropylene.

According to a second advantageous embodiment of the inertia mass in the form of the flexible heavy layer, the flexible heavy layer contains a flexible rubber-based plastic composition. Preferably, it is a butyl rubber, which commonly is also referred to as butyl. It is furthermore preferred that such a heavy layer has a density of about 2.0 to about 2.2 g/cm³. In order to confer also in this case advantageous characteristics to the plastic composition, especially to suppress hardening or embrittling of the same, said plastic composition, especially in the form of said butyl rubber, contains foreign plastics. As foreign plastics, for example thermoplastic elastomers and/or polyamide compounds are suitable.

In order to stabilize the bituminous composition or plastic composition of the heavy layer in the form of the matt-like built-on or built-in part—mass pad, it is preferably provided that the heavy layer, on its bottom side, contains or comprises a planar element. Said planar element may for example be formed by a batt or a nonwoven web of synthetic fibers or natural fibers, such as a glass fiber matt or a glass fiber nonwoven matt, by one or more paper sheets or the like. A simple and low-cost measure for attaching the matt-like built-on part, or the matt-like heavy layer, to the bottom side of the outer panel, respectively, is preferably such that the heavy layer, on its top side, has an adhesive means, for example a self-adhesive acrylate adhesive, or having applied thereto such a self-adhesive acrylate adhesive. The inertia mass that is described in detail above, in the form of the flexible heavy layer is especially suitable for adjusting the mass inertias of front lids of light metal, especially aluminum or an aluminum alloy, in view of a minimum possible HIC value. However, the disclosure is not limited to aluminum or said aluminum alloy material, but also encompasses any suitable light-weight metal material, such as for example magnesium, a plastic material or even a fiber-reinforced plastic material.

The disclosure also relates to a vehicle, especially motor vehicle, having a front lid of the above-described type.

The method for manufacturing a front lid for a vehicle, especially motor vehicle, which front lid has an outer panel, wherein, in a predetermined region or in the complete area of the front lid below the outer panel, at least one inertia mass is arranged, essentially is characterized by using a flexible heavy layer as an inertia mass, advantageously allowing convenient and effective adjustment of the mass inertia of the front lid, in view of obtaining a HIC value as low as possible, without additionally stiffening the front lid, and, simultaneously, with simple and low-cost manufacture and methoding.

### BRIEF DESCRIPTION OF THE DRAWINGS

In the following, exemplary embodiments of the inventions of the disclosure are explained in more details by way of the working examples, schematically represented in the drawings. However, it is not limited thereto, but encompasses all configurations as set forth in the claims. In the drawings:

FIG. 1, very schematically, shows a side view of a vehicle including a front lid formed according to the invention;

FIG. 2 shows a schematic sectional view of the front lid of FIG. 1, representing an inventive inertia mass of the front lid according to a first variant of the invention in the form of a mass pad (line, I-I″ in FIG. 3);

FIG. 3 shows a back layer of the front lid of FIG. 2;

FIG. 4 shows an inertia mass modified in relation to FIG. 2 and formed as a mass pad;

FIG. 5 shows a second variant of the invention;

FIG. 6 shows a diagram including three acceleration (a) time (t) curves A, B′, C′, which curve A relates to a front lid panel of steel and the curves B′ and C′ each relate to a front lid panel of a specified aluminum alloy having an inventive inertia mass, and

FIG. 7 shows a diagram having three acceleration (a) time (t) curves A, B, C, which curve A relates to a front lid panel of steel and the curves B and C each relate to a front lid panel of a specified aluminum alloy lacking an inertia mass (prior art).

### DETAILED DESCRIPTION

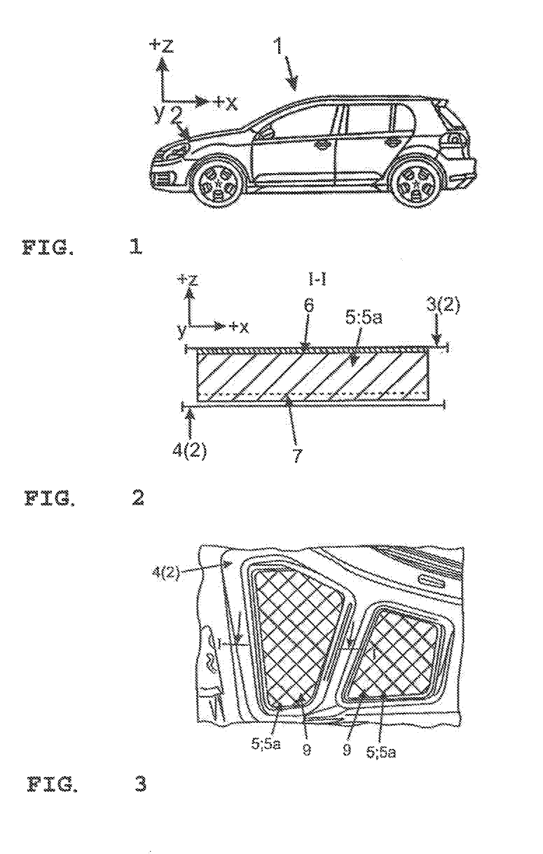

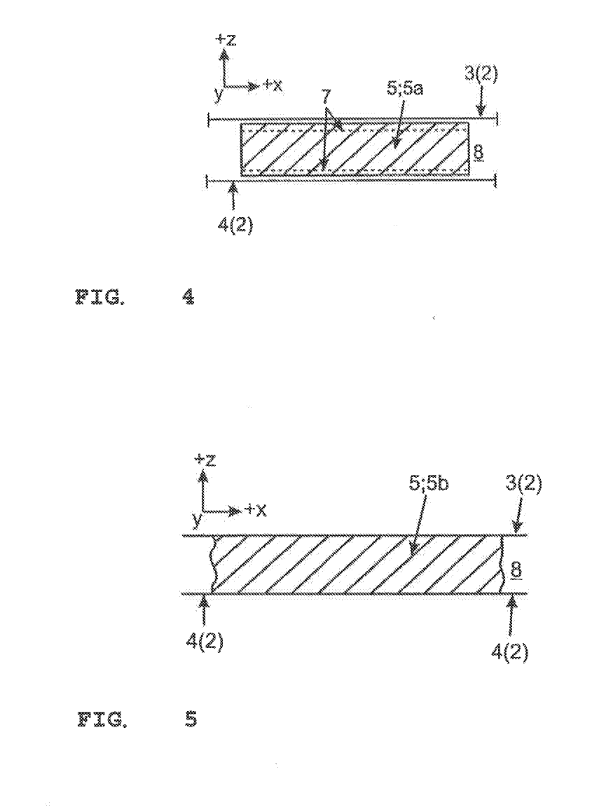

FIG. 1 shows a vehicle 1, which, in the present disclosure, is a passenger car, having a front lid 2, which, according to this embodiment, is manufactured of aluminum alloy sheet. However, the invention is not limited to aluminum or said aluminum alloy as a material, but also encompasses any suitable light-weight construction material, such as for example magnesium, plastics or even fiber-reinforced plastics. According to FIGS. 2 to 4, the front lid 2, in the closed state thereof, has an outer top panel 3 as well as an underlying internal structure 4 firmly bonded to the outer panel 3. The outer panel 3 and the internal structure 4 are firmly bonded to each other in selected regions, for example are glued to each other. Said internal structure 4 essentially is for stiffening the front lid 2. The internal structure 4 may be formed as a closed planar element, eventually including stiffening ribs (not shown in the drawings) or the like. Alternatively, it may have at least one recess 9 in predetermined regions (FIG. 3). Moreover, the internal structure 4, in predetermined regions, is arranged spaced apart from the outer panel 3. The predetermined regions, formed of said recess(es) 9 in the internal structure 4 and/or said spacing(s), are provided, among others, at locations, which, in case of an eventual collision of the vehicle 1 with a pedestrian, the same would presumably hit with his head, as it has been revealed as a result of extensive trials.

In order to at least effectively minimize the harmful effects of this collision for the respective pedestrian, at least one inertia mass 5 is arranged at least in said predetermined regions below the outer panel 3 on the same. In the present invention, the inertia mass 5 is formed of a flexible heavy layer 5a, 5b.

Variant 1 (FIGS. 2 to 4):

According to the FIGS. 2 and 3, the flexible heavy layer 5a is formed as a matt-like built-on component—mass pad—and, on its top side, having an adhesive means 6 or being provided with such to become attached in the region of the recess 9 to the backside of the outer panel 3. In FIG. 3, only two recesses 9 are shown as an example, wherein, in each of which, a mass pad of the heavy layer 5a is arranged. The adhesive means 6 is for example formed of a self-adhesive acrylate adhesive.

Contrary to this, FIG. 4 shows a flexible heavy layer 5a in the form of a mass pad, which is introduced or inserted, respectively, as a matt-like mounting component into a cavity 8 formed between the outer panel 3 and the internal structure 4. According to this working example, gluing the mass pads to each other was omitted, but may of course be provided, if this is considered as being suitable.

According to a preferred first embodiment of this first variant, the heavy layer 5a contains a bituminous composition having a density of 2.0 to 2.6 g/cm³. However, the invention is not limited to that specified density, but also encompasses density values different therefrom, preferably those that are correspondingly higher. For conferring advantageous characteristics to the bituminous composition, especially suppressing hardening or embrittling of the bituminous composition, as well as setting a specific elasticity or flexibility, the bituminous composition preferably comprises a plastic material. That plastic material, for example, may be formed by a copolymer, such as for example polypropylene.

For stabilizing the bituminous composition in the form of the matt-like built-on parts—mass pads—especially at high temperatures during introduction of the same into the vehicle shell, it is preferably provided that the composition, at least at its backside, contains or comprises a planar element 7. Said planar element 7 may, for example, be formed of a batt or nonwoven web of synthetic or natural fibers, such as a batt or nonwoven web of glass fiber, which batt or nonwoven web will then be impregnated with the bitumen (FIGS. 2 and 4). Alternatively, one or more sheets of paper or the like may be provided as a lower end of the heavy layer 5a sein (not shown in the drawings).

Of course, it is understood by the person skilled in the art and is as well encompassed by the invention that not only one sheet of mass pads may be provided, but, at least in certain regions, also two or more sheets be arranged one over the other to allow optimal adjustment of the mass inertia of front lids 2 (not shown in the drawings) in view of a smallest possible H1C value.

In trials concerning the disclosure, the following exemplary composition for the above described mass pad having bituminous composition has been proven successfully:

| | |
|---|---|
| mixture of bitumen | 8-20% |
| thermoplastic polymers | 15-20% |
| rubbers | 2-6% |
| mineral fillers | 5-10% |
| heavy fillers, such as ferrous oxide | 38-50% |
| modifiers and stabilizers | 8-12% |

The above-described composition allows manufacture of a mass pad especially having the following parameters:
density: 2.0-2.6 g/cm³
thickness: 2-6 mm
basis weight: 4-16 Kg/m²
thermal stability 210° C. in perpendicular as well as overhead position during 45 min
high cold flexibility
resistance against aqueous and alcoholic solutions, diluted acids and bases—long term functional insulation and damping characteristics

Thus, such a bitumen-based mass pad, after having been modified by polymeric portions, appropriate fillers and functional additives, shows good flexibility, thermal stability as well as long-term corrosion protection performance. By the use of a high quality pressure sensitive adhesive based on said acrylate, good adhesion even on lubricated or oiled aluminum sheet is possible.

According to a previously described alternative second embodiment of said first variant, the heavy layer 5a contains a flexible rubber-based plastic composition. Preferably, it is a butyl rubber, which generally is also referred to as butyl. It is furthermore preferred, that said plastic composition has a density of about 2.0 to about 2.2 g/cm³. However, the invention is not limited to those density specification concretely described, but also encompasses density values differing therefrom, preferably those that are correspondingly higher. For also conferring advantageous characteristics to that plastic composition, especially suppressing hardening or embrittling of the same, said plastic composition, especially in the form of the butyl rubber, comprises extrinsic plastics. As an extrinsic plastic material, for example thermoplastic elastomers and/or polyamide compounds are suitable. According to the above-described first embodiment, it may be provided that also the plastic composition, on its backside, contains or comprises a planar element 7 of the previously described type for stabilizing the plastic composition.

In trials concerning the the application, the following exemplary composition has proven to be successful for this mass pad having flexible plastic composition:

| | |
|---|---|
| solid thermo-elastic butyl rubber | 3-7% |
| oligomeric and low molecular liquid | 10-16% |
| butyl compounds | |
| thermoplastic elastomers | 4-10% |
| thermoplastic polyamide compounds | 1-3% |
| plastic resins | 4-8% |
| heavy fillers | 50-65% |
| stabilizers and pigments | 3-5% |
| thixotropic materials | 2-5% |

The composition above allows manufacture of a mass pad especially with the following parameters:
density: 2.0-2.2 g/cm³
thickness: 2-6 mm
basis weight: 4-13 Kg/m²
thermal stability 210° C. in perpendicular position as well as overhead position within 45 min
adhesion to oiled substrates,
resistance against aqueous and alcoholic solutions, diluted acids and bases

Such a mass pad has self-adhesive as well as thermoplastic characteristics. Following mounting and submission to the standard vehicle manufacturing method the mass pad functions as an elastomer. Essentially, only the effect of the mass as well as insulation effects are to be seen. There are no merely stiffening and attenuating effects to be seen.

Variant 2 (FIG. 5):

This variant essentially differs from the above in that, according to FIG. 5, the heavy layer 5b formed by a bitumen- or plastic composition will not be provided as a mass pad, but is injected as a viscous mass into a cavity 8 formed by a spacing between the outer panel 3 and the internal structure 4 and is adhered thereto by adhesion and following this sets to a flexible inertia mass 5. The characteristics thereof may also be broadly adjusted by specific portions of ingredients (see above).

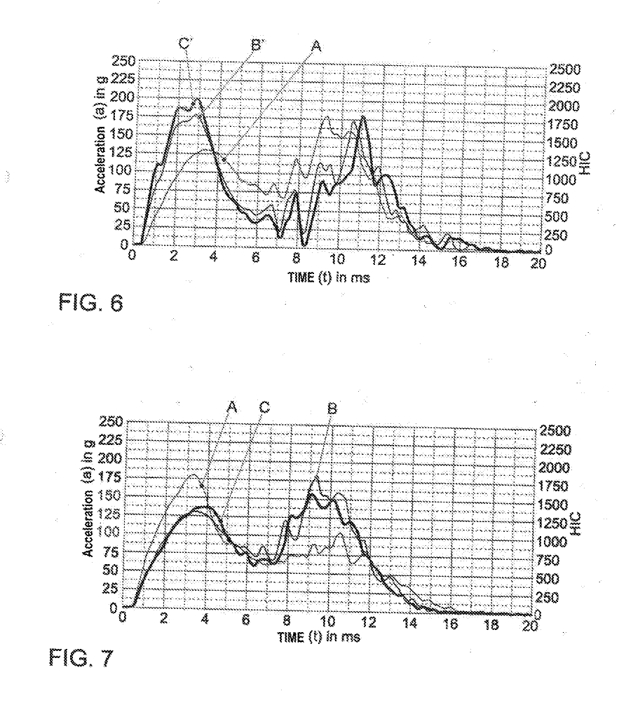

FIG. 6 only exemplary shows a diagram including three acceleration (a) time (t) curves A, B′, C′, also referred to as head impactor retardation curves, wherein the curve A relates to a front lid panel of steel (prior art) and the curves B′ and C′ each relate to a front lid panel of for example a specific aluminum alloy having at least one inertia mass 5 of the present invention. In comparison to prior art (FIG. 7), it may be seen for the front lid panels of an aluminum alloy having inertia mass(es) 5 of the present invention that a first acceleration peak of the curves B′,C′ in relation to the respective front lid 2 of said aluminum alloy is increased to an optimum level (preferably as high as for a front lid 2 of steel) for the deceleration of the head impactor, and in the present disclosure, even exceeds that level. An optimum acceleration course will result (1st acceleration peak of ⅔ height and 2nd acceleration peak of ⅓ height). From this, a better HIC value having shorter deformation path of the front lid 2 than conventionally results for the front lid panels of an aluminum alloy used as an example, having inertia mass 5 of the previously described type. Moreover, it is to be noted that the overall mass set according to the invention, of the aluminum panel including inertia mass 5 (heavy layer 5a, 5b) is significantly lower than a steel reference equally performing in relation to HIC and deformation path.

As to binding the inertia mass 5 (heavy layer 5a, 5b) formed according to the invention and the front lid 2 of the vehicles 1, in relation to the above-described method step CDC (CDC=cathodic dip coating) and dependent on the specific design of the inertia mass 5 as a heavy layer 5a or as a mass pad or as an injected or molded-on heavy layer 5b, respectively, for example, the following methoding steps may result.

It may, for example, be provided that the inertia mass 5 is first joined to the outer panel 3 in the form of at least one mass pad (heavy layer 5a), and is preferably glued, and subsequently the internal structure 4 is adhered to the outer panel 3. The mass pad is now located between the outer panel 3 and the internal structure 4 (cf. FIG. 2-4), for example in the region of a recess 9 of the internal structure 4 (FIG. 3). Thereafter, the complete front lid 2 is submitted to the CDC method.

Contrary to this, it may also be provided that after the front lid 2 having been submitted to a CDC method, injectable inertia mass 5 (heavy layer 5b) is injected into a cavity 8 formed between the outer panel 3 and the internal structure 4 (cf. FIG. 5).

1. A front lid for a motor vehicle, comprising:
an outer panel; and
an inertia mass arranged in a predetermined region or in the entire area of the front lid below the outer panel;
wherein said inertia mass is formed of a flexible heavy layer.

2. The front lid according to claim 1, wherein the inertia mass in the form of the heavy layer is formed as a matt-like built-on or built-in part—mass pad—, or wherein the inertia mass in the form of the heavy layer is injected into a cavity formed between the outer panel and an internal structure that is attached to the outer panel to provide stiffening hardening.

3. The front lid according to claim 1, wherein the inertia mass in the form of the heavy layer contains a bituminous composition.

4. The front lid according to claim 3, wherein the heavy layer has a density of 2.0 to 2.6 g/cm³.

5. The front lid according to claim 3, wherein the bituminous composition contains plastics.

6. The front lid according to claim 1, wherein the inertia mass in the form of the heavy layer contains a flexible rubber-based plastic composition.

7. The front lid according to claim 6, wherein the heavy layer has a density of 2.0 to 2.2 g/cm³.

8. The front lid according to claim 7, wherein the plastic composition furthermore contains foreign plastics.

9. The front lid according to claim 5, wherein the heavy layer, as a matt-like built-on or built-in component—mass pad—, on its backside comprises a planar element for stabilizing the bituminous composition or plastic composition and/or, at least on its top side, comprises adhesive means for attaching the heavy layer to the backside of the outer panel.

10. The front lid according to claim, wherein at least the outer panel comprises aluminum or an aluminum alloy, magnesium, plastics, fiber-reinforced plastic or another suitable light-weight construction material.

11. A motor vehicle, having a front lid according to claim 1.

12. A method for manufacturing of a front lid for a motor vehicle, which front lid comprises an outer panel, wherein in a predetermined region or in the entire area of the front lid below the outer panel at least one inertia mass is arranged, wherein a flexible heavy layer is used as an inertia mass.
